(19) United States
(12) Patent Application Publication
(10) Pub. No.: US 2026/0162486 A1
(43) Pub. Date: Jun. 11, 2026

(54) STRUCTURE AND METHOD FOR MOUNTING A GAMING MACHINE TO A STAND

(71) Applicant: LNW Gaming, Inc., Las Vegas, NV (US)

(72) Inventors: Andrew CANTRILL, Bangor (AU); Jerad DEITRICK, Las Vegas, NV (US); Brian GOLDSTEIN, Las Vegas, NV (US); Timothy KELLEY, Reno, NV (US)

(21) Appl. No.: 19/181,613

(22) Filed: Apr. 17, 2025

Related U.S. Application Data
(60) Provisional application No. 63/664,210, filed on Jun. 26, 2024.

(51) Int. Cl. G07F 17/32

(52) U.S. Cl. CPC G07F 17/3216

(57) ABSTRACT

There is provided a structure and method for mounting a gaming machine to a stand. The gaming machine includes a cabinet. The structure includes first and second mating panels. The first mating panel is removably attached to a bottom end of the cabinet. The second mating panel is removably attached to a top of the stand. After the first and second mating panels are attached to the cabinet and stand, respectively, the gaming machine is lifted onto the stand, and the first and second mating panels are slidably engaged. After the first and second panels are fully mated to each other, the first and second mating panels are locked in place with, for example, a lock screw inserted, from inside the cabinet, through the first mating panel and the second mating panel.

### CROSS-REFERENCE TO RELATED APPLICATION

This patent application claims priority benefit of U.S. Provisional Patent Application No. 63/664,210 filed June 26, 2024. The entirety of the 63/664,210 Application is incorporated by reference herein.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a gaming machines and, more particularly, to a structure and method for mounting a gaming machine to a stand.

### BACKGROUND OF THE INVENTION

Gaming machines are often mounted to stands to boost the machine to a height that facilitates game play by a player that is standing or sitting in front of the machine. To support the weight of a gaming machine, a stand may be constructed of metal (e.g., heavy duty steel), hardwood, or some combination thereof. To mount the gaming machine to the stand, the gaming machine is manually lifted onto the stand with a hand-truck. Carriage bolts are then inserted through the bottom of the machine and through pre-drilled holes in the top of the stand. The bolts extend into the inside of the stand, where the bolts are secured with corresponding nuts. A significant drawback of the above process is that a service technician needs to lay on his or her back and reach inside the stand to install the nuts on those carriage bolts that are proximate a rear of the stand.

### SUMMARY OF THE INVENTION

According to an embodiment of the present invention, there is provided a structure and method for mounting a gaming machine to a stand. The gaming machine includes a cabinet. The structure includes first and second mating panels. The first mating panel is removably attached to a bottom end of the cabinet. The second mating panel is removably attached to a top of the stand. After the first and second mating panels are attached to the cabinet and stand, respectively, the gaming machine is lifted onto the stand, and the first and second mating panels are slidably engaged. The second mating panel may, for example, be sized to sit within a cavity formed by first mating panel. After the first and second panels are fully mated to each other, the first and second mating panels are locked in place (such that they cannot slide relative to each other) with, for example, a lock screw inserted, from inside the cabinet, through the first mating panel and the second mating panel.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is an assembled three-dimensional view of a gaming machine mounted to a stand according to an embodiment of the present invention.

FIG. 2 is a block diagram of a gaming system according to an embodiment of the present invention.

FIG. 3 is a fully exploded three-dimensional view of the gaming machine, the stand, and first and second mating panels for mounting the gaming machine to the stand, according to an embodiment of the present invention.

FIG. 4 is a partially exploded three-dimensional view of the gaming machine and the stand after the first and second mating panels have been attached to the gaming machine and stand, respectively, and while the gaming machine is being slid onto the stand.

FIG. 5 is a close-up three-dimensional view, from below, of the first and second mating panels prior to sliding the first mating panel (which is attached to the bottom end of a gaming machine) over the second mating panel (which is attached to the top of a stand).

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

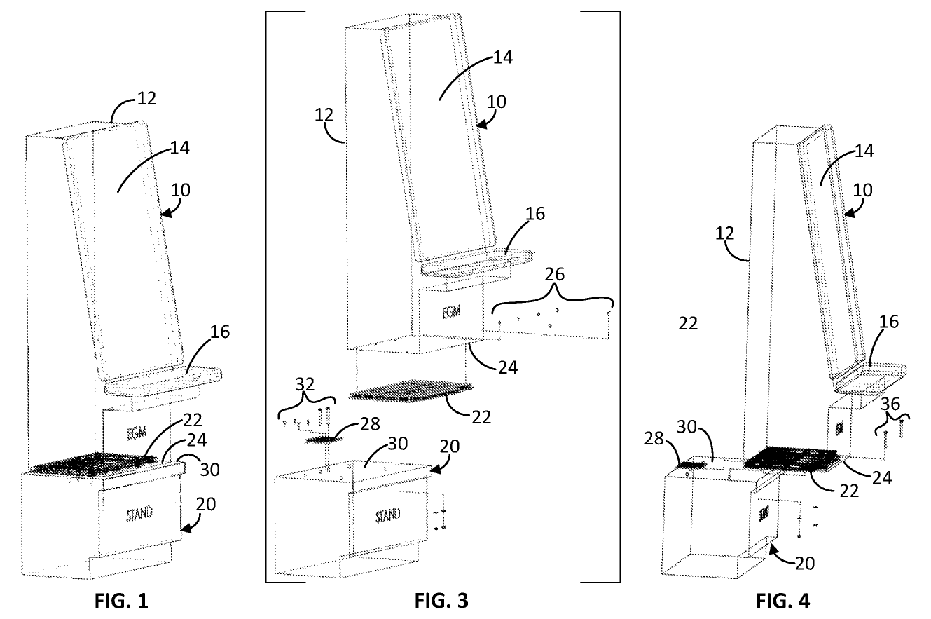

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may be primarily dedicated for use in playing wagering games. Exemplary types of gaming machines are disclosed in US Patent Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. A notification mechanism, such as a candle or tower light, may be mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. The output devices may include a presentation device(s) 14 and one or more audio speakers. The presentation device(s) 14 may be a mechanical-reel display device, a video display device, or a combination thereof. In one such combination disclosed in U.S. Patent No. 6,517,433, a transmissive video display is disposed in front of the mechanical-reel display to portray a video image superimposed upon electro-mechanical reels. In another combination disclosed in U.S. Patent No. 7,654,899, a projector projects video images onto stationary or moving surfaces. In yet another combination disclosed in U.S. Patent No. 7,452,276, miniature video displays are mounted to electro-mechanical reels and portray video symbols for the game. In a further combination disclosed in U.S. Patent No. 8,591,330, flexible displays such as OLED or e-paper displays are affixed to electro-mechanical reels. The aforementioned U.S. Patent Nos. 6,517,433, 7,654,899, 7,452,276, and 8,591,330 are incorporated herein by reference in their entireties.

The presentation device(s) 14 and any audio speakers, lighting assemblies, and/or other devices associated with presentation are collectively referred to as a “presentation assembly” of the gaming machine 10. The presentation assembly may include one or more of the foregoing devices associated with presentation. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the presentation device(s) 14, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) mounted over the presentation device(s) 14, buttons on a button panel 16, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player’s desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a game credits meter. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, a bill/ticket acceptor, a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the game credits meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

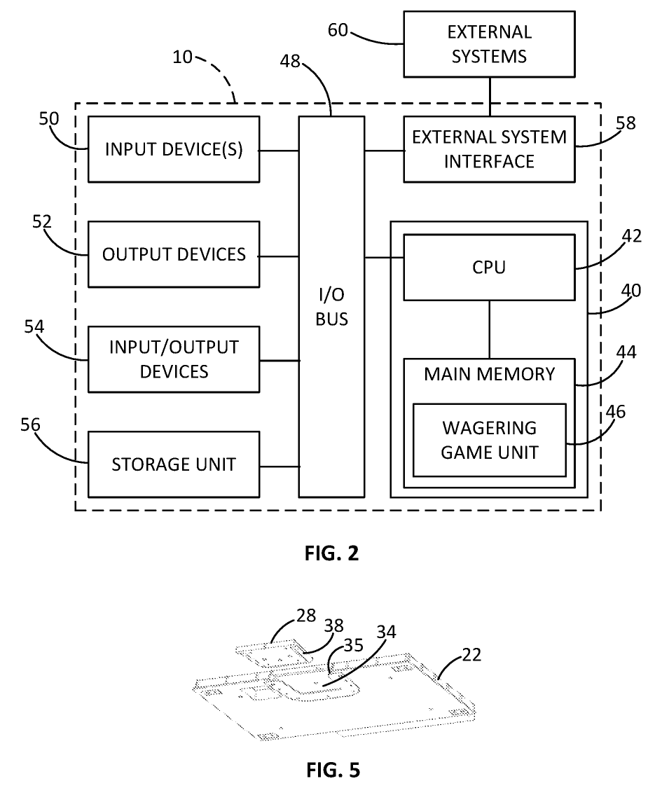

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player’s portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., the presentation device(s) 14) through the presentation of information such as, but not limited to, text, graphics, static images, moving images, etc., or any combination thereof. In accord with the method of conducting the wagering game, the game-logic circuitry 40 transforms a physical player input, such as a player’s pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the presentation device(s) 14, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state’s gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

Referring now to FIGS. 1, 3, 4 , and 5, there is provided a structure and method for mounting the gaming machine 10 to a stand 20. As noted above, the gaming machine 10 includes the cabinet 12. A first rectangular mating panel 22 is removably attached to a bottom end 24 of the cabinet 12 by a first set 26 of bolts or screws inserted into corresponding apertures in the bottom end 24. In one embodiment, the first mating panel 22 serves as the bottom panel of the cabinet 12 such that the bottom end 24 is open to an interior of the cabinet 12 prior attaching the first mating panel 22. In another embodiment, the cabinet 12 already includes a bottom panel, and the first mating panel 22 is attached to that bottom panel. A second rectangular mating panel 28 is removably attached to a top 30 of the stand 20 by a second set 32 of bolts or screws inserted into corresponding apertures in the top 30. Two different types of bolts or screws 32 are shown in FIG. 3, and the type used to attach the second mating panel 28 to the top 30 of the stand 20 depends upon the construction of the stand 20. The second mating panel 28 is attached to a rear portion of the top 30 of the stand 20 wherein a rear edge of the panel 28 is aligned with a rear edge of the top 30 and wherein the panel 28 is centered between the left and right edges of the top 30.

After the first and second mating panels 22 and 28 are attached to the cabinet 12 and stand 20, respectively, the gaming machine 10 is manually lifted onto the front portion of the top 30 of the stand 20 with a hand-truck and then the first and second mating panels 22 and 28 are slidably engaged until the second mating panel 28 is fully seated within the first mating panel 22. As shown in FIG. 5, a bottom side of the first mating panel 22 forms a shallow, rectangular guiding cavity 34. The length and width of the cavity 34 are slightly greater than the length and width of the second mating panel 28. The cavity 34 is defined by an outer profiled edge 35 forming a first shelf. The second mating panel 28 has an outer profiled edge 38 forming a second shelf. As the first mating panel 22 is slid over the second mating panel 28, the cavity 34 in the first mating panel 22 guides the two panels together until the second mating panel 28 is fully seated within the cavity 34. The cavity 34 is sized to snugly receive the second mating panel 28 with the first and second shelves along the edges 35 and 38 overlapping each other. After the first and second panels 22 and 28 are fully mated to each other, the first and second mating panels 22 and 28 are locked in place (such that they cannot slide relative to each other) with, for example, lock screws 36 inserted, from inside the cabinet 12, through the first mating panel 22 and the second mating panel 28. In another embodiment, the first and second mating panels 22 and 28 are locked in place with a spring-loaded snap latch that automatically latches the first and second mating panels. The latch may have a first latching component on the first mating panel 22 and a second latching component on the second mating panel 28. As the first and second mating panels 22 and 28 become fully mated (i.e., the second mating panel 28 becomes fully seated within the cavity 34), one of the latching components snaps into the other of the latching components. To strengthen the first and second mating panels 22 and 28 and minimize the possibility of cracking or breaking either panel as the cabinet 12 is installed on, and secured to, the stand 20, the first and second mating panels 22 and 28 may be composed of injection-molded plastic with reinforcing ribs, and the shelf-forming outer edge 35 of the cavity 34 may be composed of sheet metal represented by the U-shaped piece in FIG. 5.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to "one embodiment" or "an embodiment" mean that the feature being referred to is included in at least one embodiment of the invention. Further, separate references to "one embodiment" in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase "exemplary embodiment" means that the embodiment being referred to serves as an example or illustration.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method for mounting a gaming machine to a stand, the gaming machine including a cabinet, the method comprising the operations of:
removably attaching a first mating panel to a bottom end of the cabinet;
removably attaching a second mating panel to a top of the stand;
slidably engaging the first and second mating panels; and
after the engaging operation, attaching the first and second mating panels such that the panels cannot slide relative to each other.

2. The method of claim 1, wherein the second mating panel is sized to fit within a cavity formed by first mating panel.

3. The method of claim 2, wherein the cavity has an outer profiled edge forming a first shelf, and the second mating panel has an outer profiled edge forming a second shelf, and wherein the engaging operation includes sliding the second mating panel into the cavity with the first and second shelves overlapping each other.

4. The method of claim 1, wherein the operation of removably attaching the first mating panel to the bottom end of the cabinet includes bolting the first mating panel to the bottom end of the cabinet, and wherein the operation of removably attaching the second mating panel to the top of the stand includes bolting the second mating panel to the top of the stand.

5. The method of claim 1, wherein the attaching operation includes inserting, from inside the cabinet, a lock screw through the first mating panel and the second mating panel.

6. The method of claim 1, wherein the attaching operation includes automatically latching the first and second mating panels.

7. The method of claim 6, wherein the latching operation utilizes a spring-loaded snap latch having a first latching component on the first mating panel and a second latching component on the second mating panel.

8. The method of claim 1, wherein the first mating panel is comprised, at least in part, of sheet metal, and the second mating panel is comprised of plastic.

9. A structure for mounting a gaming machine to a stand, the gaming machine including a cabinet, the method comprising the operations of:
a first mating panel configured to be removably attached to a bottom end of the cabinet; and
a second mating panel configured to be removably attached to a top of the stand;
wherein the first and second mating panels are configured to be slidably engaged and then locked in place such that the panels cannot slide relative to each other.

10. The structure of claim 9, wherein the second mating panel is sized to fit within a cavity formed by first mating panel.

11. The structure of claim 10, wherein the cavity has an outer profiled edge forming a first shelf, and the second mating panel has an outer profiled edge forming a second shelf, and wherein the second mating panel is sized to slide into the cavity with the first and second shelves overlapping each other.

12. The structure of claim 9, wherein the first mating panel is configured to be bolted to the bottom end of the cabinet, and wherein the second mating panel is configured to be bolted to the top of the stand.

13. The structure of claim 9, wherein the first and second mating panels are locked in place with a lock screw that is inserted, from inside the cabinet, through the first mating panel and the second mating panel.

14. The structure of claim 9, wherein the first and second mating panels are locked in place with a latch that automatically latches the first and second mating panels.

15. The structure of claim 14, wherein the latch is a spring-loaded snap latch having a first latching component on the first mating panel and a second latching component on the second mating panel.

16. The structure of claim 9, wherein the first mating panel is comprised, at least in part, of sheet metal, and the second mating panel is comprised of plastic.

17. A structure for mounting a gaming machine to a stand, the gaming machine including a cabinet, the method comprising the operations of:
a first mating panel removably attached to a bottom end of the cabinet; and
a second mating panel removably attached to a top of the stand;
wherein the first and second mating panels are slidably engaged and then locked in place such that the panels cannot slide relative to each other.

18. The structure of claim 17, wherein the second mating panel is sized to fit within a cavity formed by first mating panel, wherein the cavity has an outer profiled edge forming a first shelf, and the second mating panel has an outer profiled edge forming a second shelf, and wherein the second mating panel is sized to slide into the cavity with the first and second shelves overlapping each other.

19. The structure of claim 17, wherein the first and second mating panels are locked in place with a lock screw that is inserted, from inside the cabinet, through the first mating panel and the second mating panel.

20. The structure of claim 17, wherein the first and second mating panels are locked in place with a latch that automatically latches the first and second mating panels.
